(19) United States
(12) Patent Application Publication
(10) Pub. No.: US 2024/0330710 A1
(43) Pub. Date: Oct. 3, 2024

(54) BACKGROUND THEORY-BASED METHOD FOR REFINEMENT AND EVALUATION OF FUNCTIONAL MODELS EXTRACTED FROM NUMERICAL DATA

(71) Applicant: INTERNATIONAL BUSINESS MACHINES CORPORATION, ARMONK, NY (US)

(72) Inventors: Lior Horesh, North Salem, NY (US); Cristina Cornelio, Zürich (CH); Bachir El Khadir, White Plains, NY (US); Sanjeeb Dash, Croton on Hudson, NY (US); Joao P. Goncalves, Wappingers Falls, NY (US); Kenneth Lee Clarkson, Madison, NJ (US)

(21) Appl. No.: 18/194,605

(22) Filed: Mar. 31, 2023

(51) Int. Cl. G06N 5/01

(52) U.S. Cl. CPC G06N 5/013

(57) ABSTRACT

A method generates automated discovery of new scientific formulas. The method includes receiving a background theory associated with a phenomenon being studied. The processor receives a set of training data associated with the phenomenon being studied. The set of training data is processed in a machine learning model that generates candidate formulas from data points in the set of training data. Values of a numerical error-vector are generated for the candidate formulas. The candidate formulas are processed in a reasoning model. The operation of the reasoning model includes generating values of a theoretical error-vector based on the background theory. An output of a performance metric is generated based on a generalization of the theoretical error-vector and a reasoning error. The processor determines whether one of the candidate formulas is a meaningful and valid new scientific formula, based on a behavior of the reasoning error and the reasoning performance metric.

### STATEMENT REGARDING FEDERALLY SPONSORED RESEARCH OR DEVELOPMENT

This application has been written with Government support under Contract No.: FA8750-18-C-0098 P00 awarded by the Defense Advanced Research Projects Agency (DARPA). The Government has certain rights in this invention

### BACKGROUND

### Technical Field

The present disclosure generally relates to computing arrangements using knowledge-based models, and more particularly, to automated discovery and verification of scientific formulas from a background theory.

### Description of the Related Art

Artificial neural networks (NN) and statistical regression are commonly used to automate the discovery of patterns and relations in data. NNs return “black-box” models, where the underlying functions are typically used for prediction only. In standard regression, the functional form is determined in advance, so model discovery amounts to parameter fitting. In symbolic regression (SR), the functional form is not determined in advance, but is instead composed from operators in a given list (e.g., +, −, ×, and ÷) and calculated from the data. SR models are typically more “interpretable” than NN models, and involve less data. Thus, for discovering laws of nature in symbolic form from experimental data, SR may work better than NNs or fixed-form regression; integration of NNs with SR has been a topic of recent research in neuro-symbolic AI.

### SUMMARY

According to an embodiment of the present disclosure, a computer program product for automated discovery of new scientific formulas is provided. The computer program product includes one or more computer readable storage media, and program instructions collectively stored on the one or more computer readable storage media. The program instructions include receiving, by a processor, a background theory. The background theory is associated with a phenomenon being studied. The processor receives a set of training data associated with the phenomenon being studied. The set of training data is processed in a machine learning model. The operation of the machine learning model includes generating one or more candidate formulas from data points in the set of training data. Values of a numerical error-vector are generated for the one or more candidate formulas, respectively. The candidate formulas are processed in a reasoning model. The operation of the reasoning model includes generating values of a theoretical error-vector based on the background theory. An output of a performance metric is generated based on a generalization of the theoretical error-vector and a reasoning error. The processor determines whether one of the candidate formulas is a meaningful and valid new scientific formula, based on a behavior of the reasoning error and the performance metric.

According to an embodiment of the present disclosure, a method for automated discovery of new scientific formulas is provided. The method includes receiving, by a processor, a background theory. The background theory is associated with a phenomenon being studied. The processor receives a set of training data associated with the phenomenon being studied. The set of training data is processed in a machine learning model. The operation of the machine learning model includes generating one or more candidate formulas from data points in the set of training data. Values of a numerical error-vector are generated for the one or more candidate formulas, respectively. The candidate formulas are processed in a reasoning model. The operation of the reasoning model includes generating values of a theoretical error-vector based on the background theory. An output of a performance metric is generated based on a generalization of the theoretical error-vector and a reasoning error. The processor determines whether one of the candidate formulas is a meaningful and valid new scientific formula, based on a behavior of the error and the reasoning performance metric.

According to an embodiment of the present disclosure, a computing device for automated discovery of new scientific formulas is provided. The computing device includes a processor and a memory coupled to the processor. The memory stores instructions to cause the processor to perform acts including receiving, by a processor, a background theory. The background theory is associated with a phenomenon being studied. The processor receives a set of training data associated with the phenomenon being studied. The set of training data is processed in a machine learning model. The operation of the machine learning model includes generating one or more candidate formulas from data points in the set of training data. Values of a numerical error-vector are generated for the one or more candidate formulas, respectively. The candidate formulas are processed in a reasoning model. The operation of the reasoning model includes generating values of a theoretical error-vector based on the background theory. An output of a performance metric is generated based on a generalization of the theoretical error-vector and a reasoning error. The processor determines whether one of the candidate formulas is a meaningful and valid new scientific formula, based on a behavior of the reasoning error and the performance metric.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a block diagram of a computing environment for generating weighted classification trees according to an embodiment.

FIG. 2 is a block diagram of an architecture for automated discovery of scientific formulas according to an embodiment.

FIG. 3 is a block diagram of a method for automated discovery of scientific formulas according to some embodiments.

FIG. 4 is a block diagram of a method for automated discovery of scientific formulas using a binary search process according to an embodiment.

FIG. 5 is a schematic representation of an applied process consistent with embodiments.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

### Definitions

Background Theory: as used herein, a background theory refers to a logical theory, which is a collection of one or more axioms of scientific formulas.

Predictive Model: a process used to predict future outcomes by analyzing patterns in a given set of input data.

Axioms: scientific principles and formulae which are regarded as being established, accepted, or self-evidently true.

Theorem Prover: a software tool to generate automatic proof of a given theorem from a logical theory or set of axioms.

### Overview

The present disclosure generally relates to systems and methods for producing machine learning (ML) or artificial intelligence (AI) based predictive modeling of new or candidate scientific formulas. In the disclosure below the term “theorem” may be used interchangeably with the term “formula”. The automated scientific discovery method aims to discover an unknown symbolic model (using for example, symbolic regression), y=ƒ*(x) (bold letters indicate vectors) where x is the vector (x₁, . . . , xₙ) of independent variables, and y is the dependent variable. The discovered model ƒ (an approximation of ƒ)), should fit a collection of m data points ((X¹, Y¹), . . . , (X^{m}, Y^{m}), be derivable from, or close to, a background theory, have low complexity and bounded prediction error. In some embodiments, the inputs to a system of the subject disclosure are 4-tuples [symbol] [symbol] [symbol] as follows.

The Background Knowledge [symbol] is a set of domain-specific axioms expressed as logic formulae. They involve x, y, and possibly more variables that are necessary to formulate the background theory. It may be assumed that the background theory [symbol] includes the axioms to comprehensively explain the phenomena under consideration, and is consistent, in that the axioms do not contradict one another. These two assumptions guarantee that there exists a unique derivable function [symbol] for that logically represents the variable of interest y. Note that although the derivable function is unique, there may exist different functional forms that are equivalent on the domain of interest. Considering the domain with two points {0, 1} for a variable x, the two functional forms f(x)=x and f(x)=x both define the same function.

The Hypothesis Class [symbol] is a set of admissible symbolic models defined by a grammar, a set of invariance constraints to avoid redundant expressions (e.g., A+B is equivalent to B+A) and constraints on the functional form (e.g., monotonicity).

The Data [symbol] is a set of m examples, each providing certain values for x₁, . . . , xₙ, and y.

The Modeler Preferences [symbol] is a set of numerical parameters (e.g., error bounds on accuracy).

### Distance as a Measure of Model Accuracy

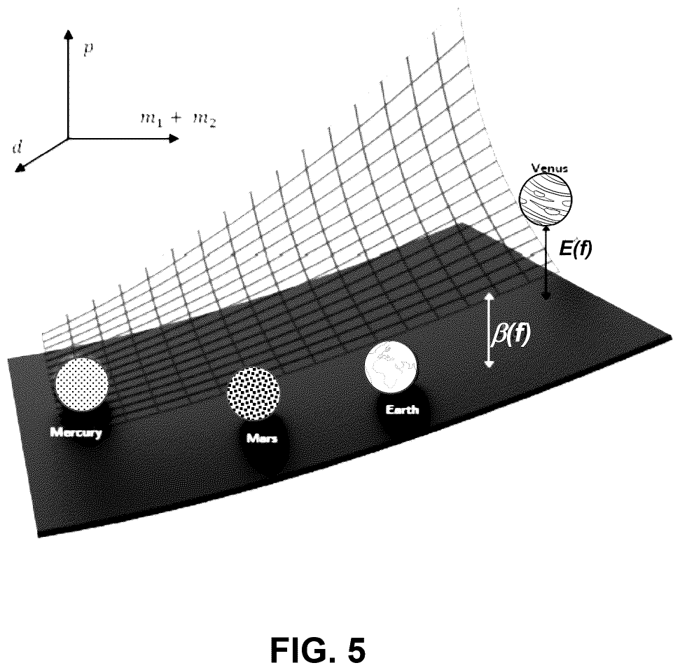

In general, there may not exist a function ƒ∈ [symbol] that fits the data exactly and is derivable from [symbol] . This may happen because the symbolic model generating the data might not belong to [symbol] , the sensors used to collect the data might give noisy measurements, or the background knowledge might be inaccurate or incomplete. To quantify the compatibility of a symbolic model with data and background theory, the subject disclosure introduces the notion of distance between a model ƒ and [symbol] Roughly, “distance” as used herein represents the error between the predictions of ƒ and the predictions of a formula [symbol] , derivable from [symbol] (thus, the distance equals zero when ƒ is derivable from [symbol] . FIG. 5 provides a visualization of the notions of distance for the problem of learning Kepler's third law of planetary motion from solar-system data and background theory.

In FIG. 5, relevant sets of data points and their distances are shown as represented by planets in the Solar system. The numerical data, background theory, and a discovered model are depicted for Kepler's third law of planetary motion giving the orbital period of a planet in the Solar system. The data comprises measurements (m₁, m₂, d, p) of the mass of the Sun m₁, the orbital period p and mass m₂ for each planet and its distance d from the Sun. The set of axioms in the background theory for this example, includes Newton's laws of motion, the formulae for centrifugal force, gravitational force, and equilibrium conditions. The 4-tuple (m₁, m₂, d, p) is projected into the coordinates system (m₁+m₂, d, p). The grid line manifold represents solutions of [symbol] which is the function derivable from the background-theory axioms that represents the variable of interest. The solid manifold represents solutions of the discovered model ƒ. The double arrows indicate the distances β(ƒ) and ε(ƒ) of ƒ from the background theory and the numerical data respectively.

A salient consideration in symbolic regression is to identify, out of many models that fit the data, those that are scientifically meaningful. Some approaches identify meaningful functions as those that balance accuracy and complexity. However, many such expressions exist for a given dataset, and not all are consistent with the known background theory.

Another approach would be to start from the known background theory, but there are no existing practical reasoning tools that generate theorems consistent with experimental data from a set of known axioms. Automated Theorem Provers (ATPs), the most widely-used reasoning tools, instead solve the task of proving a conjecture for a given logical theory. Computational complexity is a major challenge for ATPs; for certain types of logic, proving a conjecture is undecidable. Moreover, deriving models from a logical theory using formal reasoning tools is especially difficult when arithmetic and calculus operators are involved. Machine-learning techniques have been used to improve the performance of ATPs, for example, by using reinforcement learning to guide the search process. This research area has received much attention recently. Models that are derivable, and not merely empirically accurate, are appealing because they are arguably correct, predictive, and insightful. Such models may be obtained by combining a novel mathematical-optimization-based symbolic regression method with a reasoning system. This yields an end-to-end discovery system, which extracts formulas from data via symbolic regression, and then furnishes either a formal proof of derivability of the formula from a set of axioms, or a proof of inconsistency. Measures are presented that indicate how close a formula is to a derivable formula, when the model is provably non-derivable. The values of these measures are calculated using the reasoning system described herein. While some known techniques exploit prior knowledge to create additional data points, these techniques only consider constraints on the functional form to be learned.

As will be seen below, the subject technology can be used by current computer modeling platforms to improve on the accuracy of predicted models. By applying a reasoning techniques, starting from a set of axioms, on a set of candidate formulas (that are discovered through a machine learning algorithm), a “distance” can be found between candidates and the set of axioms. Knowing that the axioms represent the phenomenon under study with a high confidence, the less distance between a candidate and the axiom value indicates a high probability that the candidate theorem discovered by the machine is verifiable or close to be verifiable. As will be appreciated, the output of the subject processes represents an improvement in computer technology that provides computer discovered objects. In the subject technology, scientific formulae are discovered, which is the result of a practical application of computer implemented technology that will aid humanity in understanding the universe. The following disclosure will discuss embodiments of the subject technology in forms related to hardware implementation and processes invoked by the hardware.

### Example Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as the improved interpretable prediction code 200. The improved interpretable prediction code 200 may include a plurality of code sub-programs or modules. For example, some embodiments include a background theory retrieval engine 244, a reasoning engine 240, a machine learning model 246, and a prediction model 248. The background theory retrieval engine 244 includes code that selects a file of axioms from a database. The reasoning engine 245 applies deductive reasoning to prove candidate theorems, calculates a reasoning measures and metrics. In some embodiments, a value may be calculated for the candidate theorems (as data points). The reasoning engine 240 may compute the difference between the values of candidate theorems to the values of the derivable formula encoded by the set of axioms to determine compatibility. The difference in values may be a distance that represents the confidence level of the accuracy of the candidate theorem. The machine learning model 246 includes code that generate a model using a training data set. The prediction model 248 includes code that generates predictions from the fitted model generated by the machine learning model 246. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

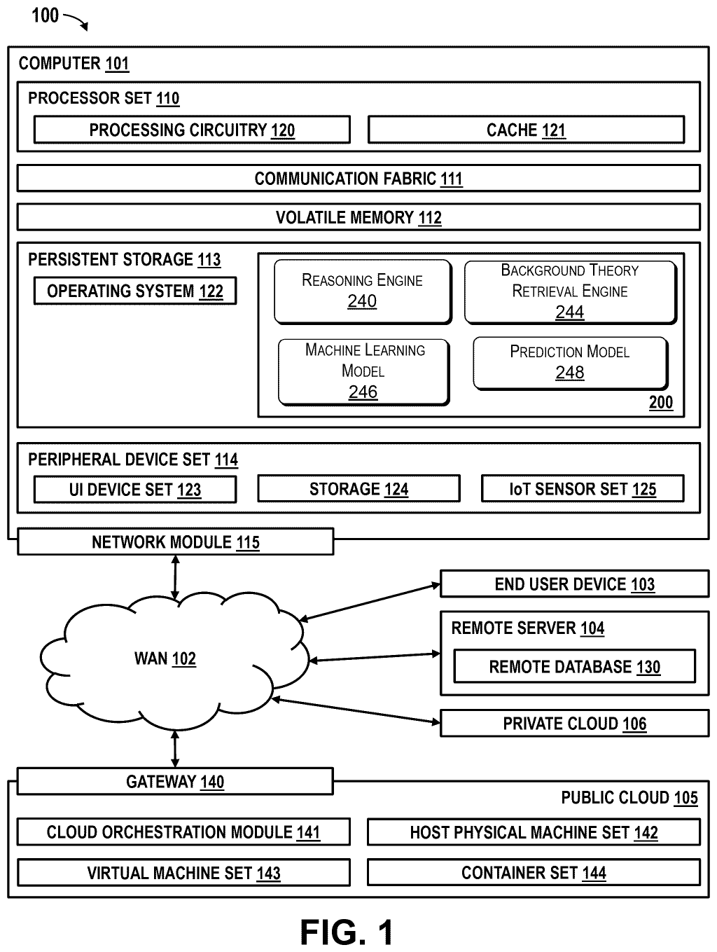

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### Example System Architecture

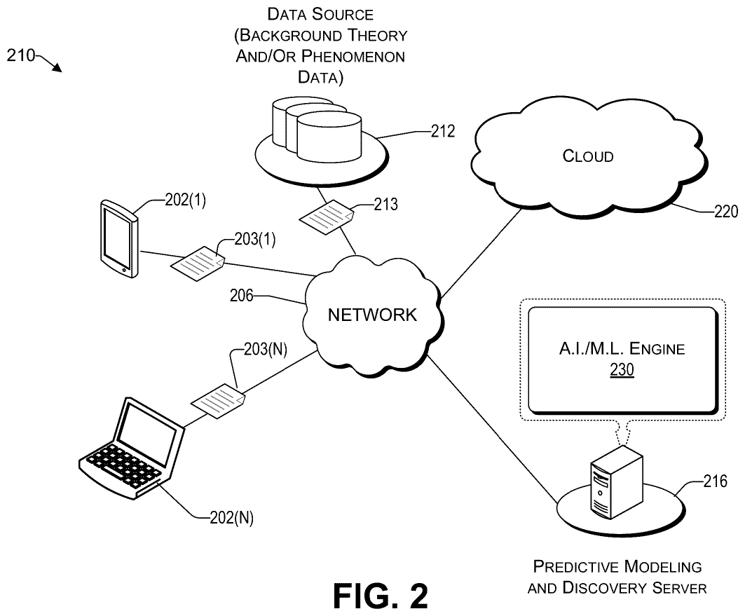

FIG. 2 illustrates an example architecture 210 for predictive modeling and discovery of scientific formulae based on distance to background theory. Architecture 210 includes a network 206 that allows various computing devices 202(1) to 202(N) to communicate with each other, as well as other elements that are connected to the network 206, such as data source 212, a predictive modeling server 216, and the cloud 220. The computing devices 202(1) to 202(N) and predictive modeling and discovery server 216 may operate under the computing environment described above in FIG. 1. The predictive modeling and discovery server 216 may operate the code 200, including the modules for the background theory engine 244, reasoning engine 245, classification training model 246, and classification prediction model 248.

The network 206 may be, without limitation, a local area network (“LAN”), a virtual private network (“VPN”), a cellular network, the Internet, or a combination thereof. For example, the network 206 may include a mobile network that is communicatively coupled to a private network, sometimes referred to as an intranet that provides various ancillary services, such as communication with various application stores, libraries, and the Internet. The network 206 allows an A.I./M.L. engine 230, which is a software program running on the predictive modeling and discovery server 216, to communicate with the data source 212, computing devices 202(1) to 202(N), and/or the cloud 220, to provide data processing. The data source 212 may include background theory data (for example, axioms) and phenomenon data (such as numerical data, training data and data samples) that will be processed under one or more techniques described here. In some embodiments, a data packet 213 may be received by the A.I./M.L. engine 230. This data packet 213 can be received by the A.I./M.L. engine 230 by either a push operation from the database 212 or from a pull operation of the A.I./M.L. engine 230. In one embodiment, the data processing is performed at least in part on the cloud 220.

For purposes of later discussion, several user devices appear in the drawing, to represent some examples of the computing devices that may be the source of data being analyzed depending on the task chosen. Aspects of the symbolic sequence data (e.g., 203(1) and 203(N)) may be communicated over the network 206 with the A.I./M.L. engine 230 of the predictive modeling server 216. Today, user devices typically take the form of portable handsets, smart-phones, tablet computers, personal digital assistants (PDAs), and smart watches, although they may be implemented in other form factors, including consumer, and business electronic devices.

For example, a computing device (e.g., 202(1)) may send a request 203(N) to the A.I./M.L. engine 230 to classify for example, different objects represented by the data samples.

While the data source 212 and the A.I./M.L. classification engine 230 are illustrated by way of example to be on different platforms, it will be understood that in various embodiments, the data source 212 and the predictive modeling and discovery server 216 may be combined. In other embodiments, these computing platforms may be implemented by virtual computing devices in the form of virtual machines or software containers that are hosted in a cloud 220, thereby providing an elastic architecture for processing and storage.

### Example Methodology

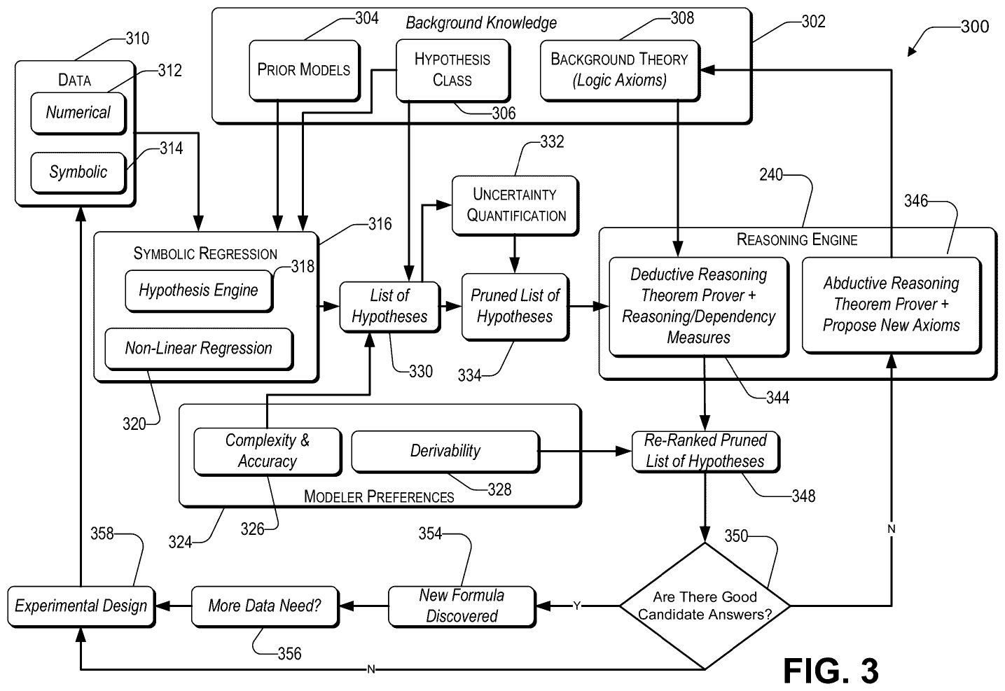

Reference now is made to FIG. 3. A computer implemented process 300 (referred to herein as simply the “process 300”) for automated discovery of new scientific formulas is shown according to an illustrative embodiment. In general, principal components of the process 300 include a symbolic regression module 316 and a reasoning engine 240. The process 300 generates hypotheses from data using symbolic regression, which are posed as conjectures to an automated deductive reasoning module 344 in the reasoning engine 240, which proves or disproves the hypotheses based on background theory or provides reasoning-based quality measures.

The following steps may be performed by a computer processor. As can be seen, the process 300 may be iterative. Generally, there are two sources of input for starting a discovery of new scientific formulas: (i) a background knowledge module 302 and (ii) a data input module 310 (both of which may be stored in the data source 212 of FIG. 2, for example). The background knowledge module 302 may include a database of prior models 304, a database constraints defining a hypothesis class 306, and a database of background theory 308 (which may include for example, logic axioms or other axioms from which candidate theorems will be compared to). The data input module 310 may include a database 312 of numerical data points and a database 314 of symbolic data. In some embodiments, constraints to be applied to the set of training data may be found in the data input module 310.

A symbolic regression module 316 may include a hypothesis engine 318 and a non-linear regression module 320. The hypothesis engine 318 may propose functional forms, the structural design of the candidate formulas. The non-linear regression module 320 may fit constraints during model building to define the numerical values contained in the structural design of the candidate formulas (also called parameter fitting) and assess the numerical-error of a model compared to the data. The symbolic regression module 316 may return multiple candidate symbolic models (or formulae) expressing y as a function of x₁, . . . , xₙ and that fit the data with different level of accuracy. For each of these models, symbolic regression module 316 outputs also the distance ε(ƒ) between ƒ and [symbol] while the reasoning module 240 outputs the distance β(ƒ) between ƒ and [symbol] . For reference, ε(ƒ) and β(ƒ) are considered errors. These functions may be tested to see if the functions satisfy the specified constraints on the functional form (in [symbol] ) and the modeler-specified level of accuracy and complexity (in [symbol] ). When the models are passed to the reasoning engine 240 (along with the background theory [symbol] ), the models may be tested for derivability (if required by block 328). If a model is found to be derivable from [symbol] the model may be returned as the chosen model for prediction; otherwise, if the reasoning engine 240 concludes that no candidate model is derivable, additional data may be collected or constraints may be added to the testing of models. In this case, the reasoning engine 240 will return a quality assessment of the input set of candidate hypotheses based on the distance β, and removing models that do not satisfy the modeler-specified bounds on B. The distance (or error) β is computed between a function (or formula) ƒ, derived from numerical data, and the derivable function [symbol] , which is implicitly defined by the set of axioms in [symbol] and is logically represented by the variable of interest y. The distance between the function [symbol] and any other formula ƒ may depends only on the background theory and the formula ƒ and not on any particular functional form of [symbol] Moreover, the reasoning engine 240 can prove that a model is not derivable by returning counterexample points that satisfy [symbol] but do not fit the model.

The symbolic regression module 316 may process training data from the data input module 310 to generate one or more models of candidate theorems as a list of hypotheses 330. In some embodiments, the symbolic regression module 316 may also use as input, data from the database of prior models 304 and the database defining the hypothesis class 306 (e.g. functions using only basic arithmetic operators +−/x). The list of hypotheses 330 generated may also use input from the database of hypothesis class 306. In some embodiments, the process 300 includes a modeler preferences module 324 that includes a complexity and accuracy module 326 and a derivability module 328. Modeler preferences may include the user preferences in the form of bounds on the numerical or reasoning errors tolerated; derivability requirement (if a candidate formula is required to be provably derivable from the background theory to be accepted), the bound on the complexity of a candidate formula or bounds on the formula accuracy. Data from the complexity and accuracy module 326 may be used to rank the list the list of hypotheses 330 as output. In some embodiments, the process 300 may include a sub-process of uncertainty quantification 332 that evaluates the output from the list of hypotheses 330 and provide, for example, a Bayesian evaluation of the likelihood of a formula. In some embodiments, the computer processor may generate a pruned list of hypotheses 334 from the list of hypotheses 330 by reducing the number of candidate theorems produced, eliminating the ones that do not fit the criteria listed in modeler preferences module 324. In some embodiments, the uncertainty quantification 332 may be used to prune the list of hypotheses 334.

The list of hypotheses 330 (or pruned list of hypotheses 334) may be received by the reasoning engine 240. The reasoning engine 240 may include a deductive reasoning module 344 and an abductive reasoning module 346. The deductive reasoning module 344 may include a theorem prover and tools to generate reasoning/dependency measures. The deductive reasoning module 344 may compare each of the hypotheses received to the axioms from the background theory module 308. In one embodiment, the deductive reasoning module 344 may quantify each of the candidate formulas by generating values for the error-vector that has one component per candidate theorem. In some embodiments, the error-vector for candidate formulas may be a numerical vector. In some embodiments, a finite set of data points (module 312) may be considered when generating error-vector values. It may be possible to find a function with high predictive accuracy for given data points. It may be more challenging to obtain good results in the area between the given points. Accurate prediction in these areas lead to generalizability and a better model. It should also be appreciated that the process 300 is flexible enough to consider additional points within the interval where specific data points lie (in between data points) when generating error-vector values based on reasoning. In some embodiments, the deductive reasoning module 344 may consider points outside of the training set of data when generating error-vector values (e.g., continuous data intervals as an extension of the discrete points in module 312). Thus, a range of outcomes becomes available where previous methods only provided discrete numbers of outcomes. The deductive reasoning module 344 may evaluate how much a formula generalizes between the data points. The deductive reasoning module 344 may generate the values for an axiom-based error-vector based on the input from the background theory. In some embodiments, the axiom-based error-vector may be a theoretical error-vector. In this manner, the processor running the deductive reasoning module 344 may compare synthetically derived values to evaluate candidate models for compatibility with the known formulas in the axioms. In some embodiments, a set of continuous data intervals (as a further extension beyond the original domain, of the discrete points in module 312) may be considered when generating the outcome of an axiom-based performance metric. The deductive reasoning module 344 may determine a performance metric based on the behavior of a reasoning error when extending the training data of one or more orders of magnitude. In some embodiments the performance metric is based on a reasoning-based dependency analysis. In some embodiment this performance metric is a binary value for each variable in the input data. In some embodiments the value is multi-valued, based on a degree of how much the reasoning measure is impacted by the order of magnitude change (e.g., linear or exponential growth).

The processor may determine (at block 350) whether one (or more) of the candidate formulas is a good candidate for a new scientific formula based on the behavior of the reasoning error and the performance metric. When a candidate is rejected, the processor may send the rejected candidate theorem back to the abductive reasoning module 346. The abductive reasoning module 346 may operate an abductive reasoner on the rejected candidate theorem to evaluate whether a new axiom should be proposed. Proposed new axioms may be provided to the background theory module 308 for consideration. In some embodiments, a rejected candidate may be forwarded to an experimental design module 358 that may propose conditions to obtain new data. In some embodiments the output of the performance metrics based on dependency analysis of module 334, can be used to: augment the hypothesis class (module 306) with new constraints; augment the symbolic data (module 314) with new constraints; and prune the set of prior models (module 304) by only keeping the ones that satisfy the performance metric. Accepted candidate theorems may be labeled as a discovered new formula 354 by the processor. In some embodiments, the candidate formula may be considered a meaningful and valid new scientific formula, based on a behavior of the reasoning error and the reasoning performance metric. The processor may evaluate whether the new formula needs more data at block 356; for example, determining whether more data is needed to support a derivable hypothesis considering alternatives. The new formula may be sent to the experimental design module 358. Output from the experimental design module 358 may be provided to the data input module 310 to supplement additional training of the symbolic regression engine 316.

### Example Automated Reasoning Process

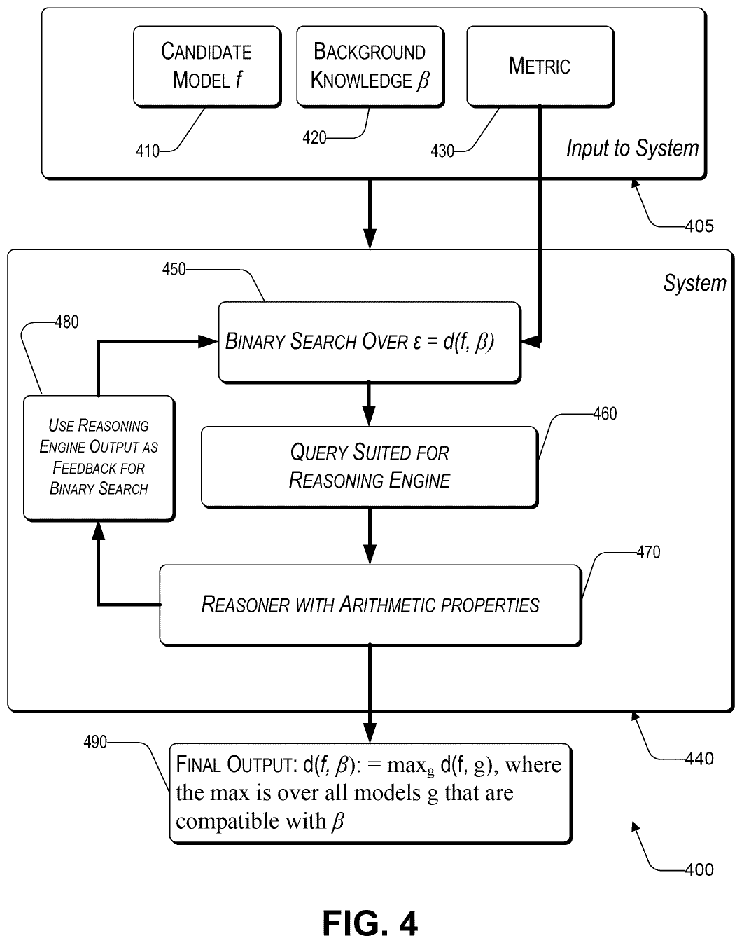

Referring now to FIG. 4, a process 400 (referred to herein as simply the “process 300”) for automated discovery of scientific formulas using a binary search process is shown. In general, the process 400 may include two modules; an input source module 405 and a reasoning system 440.

The input source module 405 may include a candidate models module 410, a Background Knowledge module 420, and a Metric input module 430. The candidate model module 410 may include stored models and newly generated candidate theorems. The Background Knowledge module 420 may include stored accepted formulas and axioms. The Metric input module 430 may provide a norm-based metric to be applied for the generation of reasoning measures.

Input from the three modules in the input source module 405 may be provided to the reasoning system 440 to determine the distance of a candidate model fto a background theory T. In one embodiment, the distance of a discovered model ƒ to background theory T is given by the maximum discrepancy d (ƒ, g) between ƒ and any formula g that is derivable from T when considering the variable of interest, i.e.

$$max d ( f , g ) s . t . T \to g \qquad ( 1 )$$

The discrepancy function depends on a choice of a norm ∥.∥ (e.g., [symbol] ₂ and [symbol] _{∞}), as a metric and can be defined in several ways.

For example, a data dependent discrepancy: Given a data set D={x₁, . . . , xₙ}, d(ƒ, g)=∥(ƒ(xᵢ)−g (xᵢ))ᵢ∥

For an Interval measure:

$$d ( f , g ) = {sup}_{\{ x ∈ B \}} \vert f ( x ) - g ( x ) \vert ,$$

where B is the cartesian product of the continuous domains in which the training data is defined.

Since the derivable formula is not known explicitly but is indirectly known through the set of axioms, this may be done using a theorem prover.

In one embodiment, the input source module 405 may be processed 450 using a binary search algorithm (e.g., for the distance ε=d(ƒ, β)) particularity useful in the common case in which the theorem prover does not have any embedded optimization algorithm and can only provide a binary outcome of proved/disproved status. The reasoning engine 440 may receive 460 a query suited for use in a theorem prover. In some embodiments, the reasoning engine 440 may determine a reasoning error, or an interval error, for one of the models of candidate theorems factoring in the norm-based metric using the binary search algorithm. The reasoning error calculation may be either point-wise or considering the whole continuous interval domain. The reasoning engine 440 may run 470 the theorem prover using arithmetic properties. In some embodiments, the output from the theorem prover may be used as feedback 480 for the binary search algorithm. The output from the theorem prover may generate 490 a final output, d (ƒ, β):=max_{g} d (ƒ, g), where the max is over all models g that are compatible with β, with a specific precision, defined by the modeler preferences. When the precision is reached, the binary search stops.

### Variable Dependency

In some embodiments, the reasoning process performed by reasoning system 440 allows for the extension of the intervals beyond the domain of the data points in the training dataset. This extension may be, in some embodiments, of at least on order of magnitude in both directions. For example, the reasoning system 440 may show data for when a formula generalizes outside the space defined by the dataset. The reasoning engine 440 may show data for when there exist special conditions for which the formula does not hold in the extended domains. To provide data in the aforementioned two scenarios, the theorem prover formulation may be programmed with intervals, while increasing (or diminishing) the interval end (or start) point by one order of magnitude for a specific variable. If a noticeable increase in the formula error is discernible, then that the formula may be considered missing a dependency on that particular variable, that can be explained as (but not limited to): (1) the exponent for a variable is too low/high; (2) that variable is not considered at all while it should be considered; and (3) the variable is considered but multiplied by/added to the wrong constant. Further considerations may be done analyzing how the formula error increases (e.g. linearly or exponentially) with the increase of the value of the variable. In some embodiments the performance metric can be returned as a vector of binary variables, one per dependent variable in the data, indicating if the dependency on that variable is satisfied or not. In some embodiments the performance metric may be a vector of multi-valued variables, one per dependent variable in the data, indicating a class of dependency on that variable (e.g., linear or exponential error increase). In some embodiments the performance metric may be a continuous vector, with one component per dependent variable in the data, indicating a degree of error increases.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer program product for automated discovery of new scientific formulas, the computer program product comprising:
one or more computer readable storage media, and program instructions collectively stored on the one or more computer readable storage media, the program instructions comprising:
receiving, by a processor, a background theory, wherein the background theory is associated with a phenomenon being studied;
receiving, by the processor, a set of training data associated with the phenomenon being studied;
processing the set of training data, in a machine learning model, wherein an operation of the machine learning model includes:
generating one or more candidate formulas from data points in the set of training data;
generating values of a numerical error-vector for the one or more candidate formulas, respectively;
processing the one or more candidate formulas, in a reasoning model, wherein an operation of the reasoning model includes:
generating values of a theoretical error-vector based on the background theory;
generating an output of a performance metric based on a generalization of the theoretical error-vector and a reasoning error; and
determining, by the processor, whether one of the candidate formulas is a meaningful and valid new scientific formula, based on a behavior of the reasoning error and the performance metric.

2. The computer program product of claim 1, wherein the performance metric is based on a reasoning-based dependency analysis.

3. The computer program product of claim 2, wherein performing the generation of the output performance metric using the reasoning-based dependency analysis, includes evaluating the behavior of the reasoning error when extending the set of training data one or more orders of magnitude.

4. The computer program product of claim 1, wherein the reasoning error includes one or more of a point-wise reasoning error or an interval error.

5. The computer program product of claim 1, wherein the background theory is a file including a set of axioms associated with the phenomenon.

6. The computer program product of claim 1, wherein the program instructions further comprise determining a value of the reasoning error, using a binary search strategy in conjunction with a theorem prover.

7. The computer program product of claim 1, wherein the program instructions further comprise performing the generation of the values of the numerical error-vector on a finite set of the data points.

8. The computer program product of claim 1, wherein performing the generation of the values of the numerical error-vector for the one or more candidate formulas, respectively, includes generating vector values considering additional points in between the data points in the set of training data.

9. A method for automated discovery of new scientific formulas, comprising:
receiving, by a processor, a background theory, wherein the background theory is associated with a phenomenon being studied;
receiving, by the processor, a set of training data associated with the phenomenon being studied;
processing the set of training data, in a machine learning model, wherein an operation of the machine learning model includes:
generating one or more candidate formulas from data points in the set of training data;
generating values of a numerical error-vector for the one or more candidate formulas, respectively;
processing the one or more candidate formulas, in a reasoning model, wherein an operation of the reasoning model includes:
generating values of a theoretical error-vector based on the background theory;
generating an output of a performance metric based on a generalization of the theoretical error-vector and a reasoning error; and
determining, by the processor, whether one of the candidate formulas is a meaningful and valid new scientific formula, based on a behavior of the reasoning error and the performance metric.

10. The method of claim 9, wherein the performance metric is based on a reasoning-based dependency analysis.

11. The method of claim 10, wherein performing the generation of the performance metric using the reasoning-based dependency analysis, includes evaluating the behavior of the reasoning error when extending the set of training data one or more orders of magnitude.

12. The method of claim 9, wherein the reasoning error includes one or more of a point-wise reasoning error or an interval error.

13. The method of claim 9, wherein the background theory is a file including a set of axioms associated with the phenomenon.

14. The method of claim 9, further comprising determining a value of the reasoning error, using a binary search strategy in conjunction with a theorem prover.

15. The method of claim 9, further comprising performing the generation of the values of the numerical error-vector on a finite set of the data points.

16. The method of claim 9, wherein performing the generation of the values of the numerical error-vector for the one or more candidate formulas, respectively, includes generating vector values considering additional points in between the data points in the set of training data.

17. A computing device for automated discovery of new scientific formulas, comprising:
a processor; and
a memory coupled to the processor, the memory storing instructions to cause the processor to perform acts comprising:
receiving, by a processor, a background theory, wherein the background theory is associated with a phenomenon being studied;
receiving, by the processor, a set of training data associated with the phenomenon being studied;
processing the set of training data, in a machine learning model, wherein an operation of the machine learning model includes:
generating one or more candidate formulas from data points in the set of training data;
generating values of a numerical error-vector for the one or more candidate formulas, respectively;
processing the one or more candidate formulas, in a reasoning model, wherein an operation of the reasoning model includes:
generating values of a theoretical error-vector based on the background theory;
generating an output of a performance metric based on a generalization of the theoretical error-vector and a reasoning error; and
determining, by the processor, whether one of the candidate formulas is a meaningful and valid new scientific formula, based on a behavior of the reasoning error and the performance metric.

18. The computing device of claim 17, wherein the performance metric is based on a reasoning-based dependency analysis.

19. The computing device of claim 18, wherein performing the generation of the performance metric using the reasoning-based dependency analysis, includes evaluating the behavior of the reasoning error when extending the set of training data one or more orders of magnitude.

20. The computing device of claim 17, wherein the reasoning error includes one or more of a point-wise reasoning error or an interval error.
